(19) United States
(12) Patent Application Publication
(10) Pub. No.: US 2013/0101709 A1
(43) Pub. Date: Apr. 25, 2013

(54) METHOD AND SYSTEM FOR ASSEMBLING A PIZZA

(71) Applicant: Pizza Hut, Inc., Plano, TX (US)

(72) Inventor: Jeff Rader, Plano, TX (US)

(73) Assignee: Pizza Hut, Inc., Plano, TX (US)

(21) Appl. No.: 13/657,122

(22) Filed: Oct. 22, 2012

Related U.S. Application Data
(60) Provisional application No. 61/550,506, filed on Oct. 24, 2011.

(51) Int. Cl. A23L 1/00; G01N 5/00

(52) U.S. Cl. 426/231; 99/493

(57) ABSTRACT

A system for assembling a pizza includes: a computer configured for receiving an order for the pizza; a database accessible by the computer for providing a list of ingredients for the pizza based on the order; a monitor operably connected to the computer and positioned in an order preparation area for displaying instructions for assembling the pizza; and a scale operably connected to the computer for continuously weighing the pizza during assembly of the pizza. The monitor then displays instructions to apply the ingredients. As the ingredients are applied to the pizza, the scale is continuously weighing the pizza and outputting a signal representative of the weight to the computer, which then displays an indication that the appropriate amount of a selected ingredient has been applied to the pizza.

### CROSS-REFERENCE TO RELATED APPLICATIONS

The present application claims priority to U.S. Provisional Patent Application Ser. No. 61/550,506 filed on Oct. 24, 2011, the entire disclosure of which is incorporated herein by reference.

### BACKGROUND OF THE INVENTION

In the process of assembling a pizza, a pizza dough is placed on or spread over a pan, stone, or other cooking implement. Sauce is applied to the top surface of the pizza dough, along with cheese and selected toppings (such as pepperoni, sausage, vegetables, etc.). The pizza is then cooked for a predetermined time period and served.

In a restaurant environment, there are a number of complexities and variables that factor into the process. For instance, varying sizes of pizza are ordinarily available from a restaurant, along with multiple crust types. The amounts of sauce, cheese, and toppings applied to the pizza are dependent on the size of the pizza and/or the type of crust. Furthermore, the amount of each individual ingredient may be varied based on the total number of toppings applied to the pizza. Thus, an individual tasked with assembling a pizza in a restaurant environment must often be able to execute a complex set of rules in assembling the pizza.

Furthermore, in a restaurant environment, especially for a restaurant chain with multiple outlets, it is important to ensure that pizzas are served with a consistent quality. In other words, each pizza must be assembled in the same manner, with the amounts of sauce, cheese, and toppings rigidly controlled in order to achieve the desired flavor profile. Furthermore, by controlling the amounts of the sauce, cheese, and toppings for each pizza, cost controls can be realized.

### SUMMARY OF THE INVENTION

The present invention is a method and system for assembling a pizza, a method and system that makes use of a scale and further provides visual instructions and/or cues to the individual tasked with assembling the pizza that are based on output from the scale.

In an exemplary implementation of the method and system of the present invention, an individual tasked with assembling a pizza is positioned in an order preparation area. The order preparation area includes a preparation table with multiple discrete bins or containers for holding various sauces, cheese, and/or toppings. Furthermore, the order preparation area includes a monitor that displays instructions and/or cues to the individual, as further described below. Finally, a scale is included in the order preparation area.

The scale is operably connected to a computer, which, in turn, is connected to the monitor. A software application is stored in a memory register on the computer. The software application is configured to receive orders for pizzas. Once a particular order is received by the computer, the computer queries a database to retrieve a list of ingredients based on the order, including the ideal amount or weight of each ingredient, taking into account the size, type of crust, and total number of ingredients in the order. The software application then generates visual instructions and/or cues to the individual tasked with assembling the pizza, which are displayed on the monitor.

For instance, the monitor first displays instructions to apply the sauce to the pizza dough. Then, the monitor displays instructions to apply cheese to the pizza, and so on. As the ingredients are applied to the pizza, the pan supporting the pizza dough is positioned on the scale. Thus, as the ingredients are applied to the pizza, the scale is continuously weighing the pizza and outputting a signal representative of the weight to the computer. The monitor then displays an indication that the appropriate amount of a selected ingredient has been applied to the pizza.

### DESCRIPTION OF THE DRAWINGS

FIG. 1 is a view of an order preparation area in an exemplary implementation of the method and system of the present invention;

FIG. 2 is a schematic representation of the core components in an exemplary implementation of the method and system of the present invention; and

FIG. 3 is a representation of a screen displayed on a monitor in an exemplary implementation of the method and system of the present invention.

### DETAILED DESCRIPTION OF THE INVENTION

The present invention is a method and system for assembling a pizza, a method and system that makes use of a scale and further provides visual instructions and/or cues to the individual tasked with assembling the pizza that are based on output from the scale.

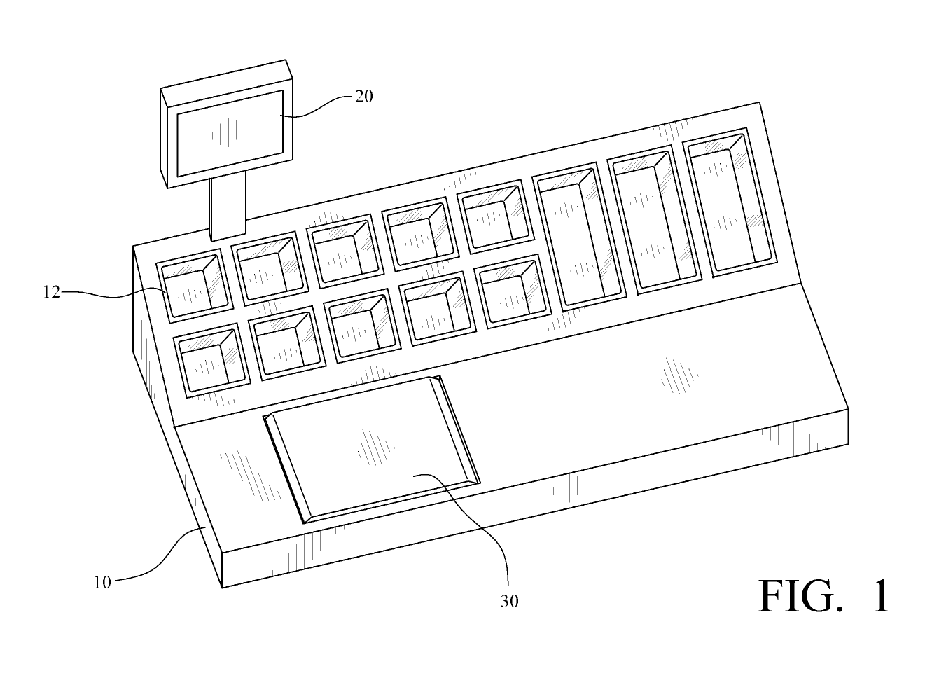

Referring first to FIG. 1, in an exemplary implementation of the method and system of the present invention, an individual tasked with assembling a pizza is positioned in an order preparation area. The order preparation area includes a preparation table 10 with multiple discrete bins or containers 12 for holding various sauces, cheese, and/or toppings. Furthermore, the order preparation area includes a monitor 20 that displays instructions and/or cues to the individual, as further described below. Finally, a scale 30 is included in the order preparation area.

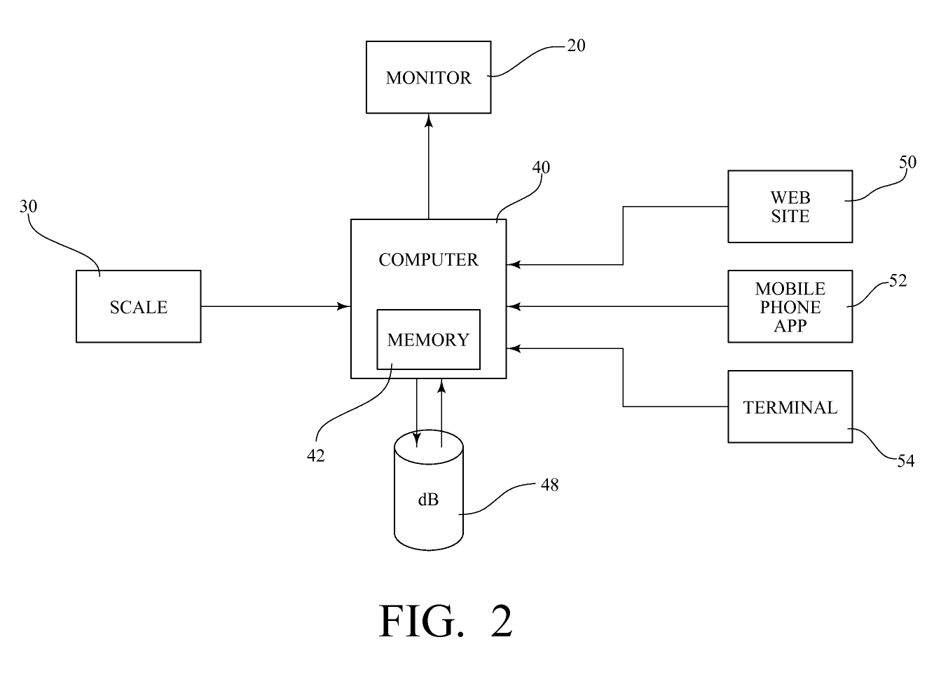

Referring now to FIG. 2, the scale 30 is operably connected to a computer 40, which, in turn, is connected to the monitor 20. A software application, i.e., a digital computer program or similar set of computer-readable instructions, is stored in a memory register 42 on the computer 40. In practice, the software application is configured to receive orders for pizzas. For example, such orders could be placed by a customer via an on-line web site 50 and communicated to the computer 40 via an Internet connection, such orders could be placed by a customer via a mobile phone application 52, or such orders could be placed by an employee using a terminal 54 in the restaurant. In any event, once a particular order is received by the computer 40, the computer queries a database 48 to retrieve a list of ingredients based on the order, including the ideal amount or weight of each ingredient, taking into account the size, type of crust, and total number of ingredients in the order. In this regard, the database 48 may be local or may be located remotely and accessible via the Internet or other computer network. The software application then generates visual instructions and/or cues to the individual tasked with assembling the pizza, which are displayed on the monitor 20.

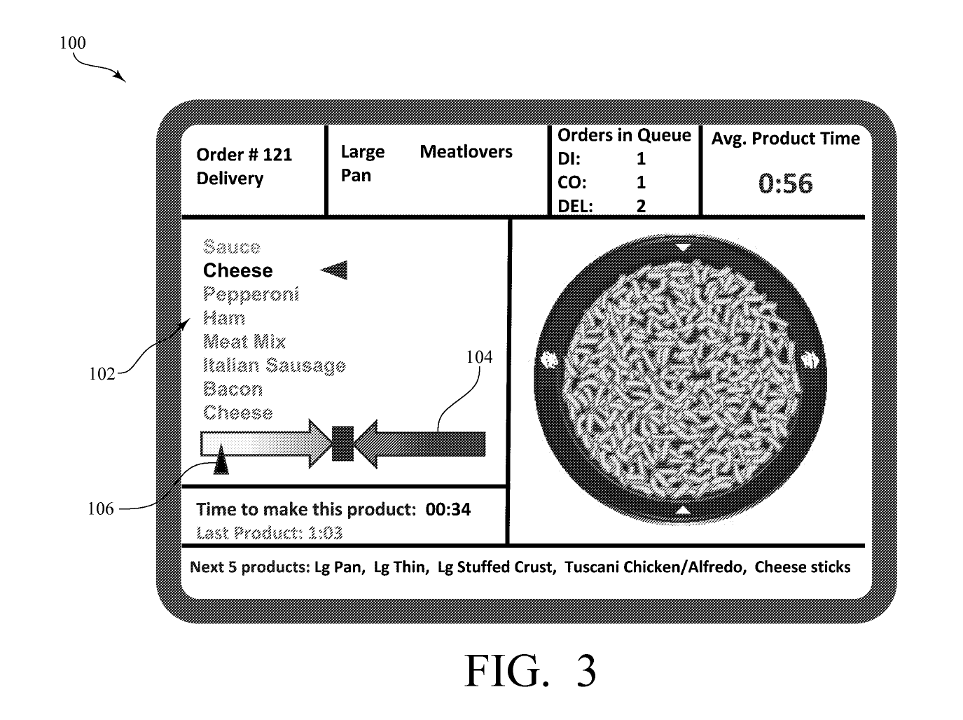

FIG. 3 is an exemplary representation of a screen 100 displayed on the monitor 20 according to the method and system of the present invention. As shown in FIG. 3, the screen 100 is divided into multiple panes. Of particular importance, in one pane, the screen 100 includes a list 102 of the ingredients that will be used to assemble the pizza—sauce, cheese, and selected toppings. This list 102 of the ingredients is presented in the order in which the ingredients (or toppings) are to be applied to the pizza. In other words, the monitor 20 displays instructions to assemble the pizza. Thus, the individual tasked with assembling the pizza is instructed, via the monitor 20, to first apply the sauce to the pizza dough. Then, the individual is instructed, via the monitor 20, to apply cheese to the pizza (as specifically illustrated in FIG. 3), and so on. Referring back to FIG. 1, as ingredients are applied to the pizza, the pan (or other cooking implement) supporting the pizza dough is positioned on the scale 30, which again is operably connected to the computer 40. Thus, as the ingredients are applied to the pizza, the scale 30 is continuously weighing the pizza and outputting a signal representative of the weight to the computer 40.

Referring again to FIG. 3, in this exemplary implementation, there is a horizontal bar 104 (or similar static icon) displayed just below the list 102 of ingredients. The software application resident on the computer 40 causes an arrowhead 106 (or similar moveable icon) to move along this bar 104 in response to the weight of the ingredients being applied to the pizza. In other words, the arrowhead 106 moves along and relative to the bar 104 in response to the increase (or decrease) of the weight of the pizza as ingredients are applied (or removed). When the arrowhead 106 is centered on the bar 104, the individual is provided with a visual indication or feedback that the appropriate amount of a selected ingredient has been applied to the pizza. Indeed, the software application can be configured such that it only advances and prompts the individual to apply the next ingredient to the pizza once the appropriate amount of the prior ingredient (within a prescribed range) has been applied to the pizza. For instance, the individual will only be prompted to apply the pepperoni to the pizza once it has been confirmed by the scale 30 that the appropriate amount of cheese has been applied to the pizza.

As should be clear from the above description, by implementing such a method and system for assembling a pizza, pizzas can be assembled in a consistent matter, resulting in improved quality and controlling costs. It also becomes much easier to introduce recipe changes and/or new recipes; specifically, rather than disseminate new written instructions and/or kitchen tools to a number of restaurants, it is only necessary to update the relevant databases with the appropriate lists of ingredients. The individuals who are tasked with assembling the pizzas require no knowledge of actual amounts. The individuals only have to apply each ingredient until receiving a visual indication or feedback that the amount is appropriate. Therefore, minor changes to the amounts of ingredients may not even be recognized by the individuals tasked with assembling the pizzas.

Finally, and referring again to FIG. 3, on the screen 100 displayed on the monitor 20, other panes can provide additional information to the individual. For example, the right pane contains a graphical image of the pizza or animation showing how the pizza is to be assembled. For another example, in a lower left pane, a running timer is displayed that provides a visual indication or feedback to the individual as to how long it is taking to assemble the pizza. This can be compared to an “average product time” presented in the upper right corner of the screen. For another example, information about orders in the queue can be displayed, such as the number of orders in the queue or the types of orders in the queue. Of course, any and all such data and information can be stored in the computer 40 and/or transmitted to a supervisor or central facility for review, analysis, and performance tracking

One of ordinary skill in the art will recognize that additional embodiments or implementations are possible without departing from the teachings of the present invention or the scope of the claims which follow. This detailed description, and particularly the specific details of the exemplary embodiments and implementations disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A method for assembling a pizza, comprising the steps of:
receiving, by a computer, an order for the pizza;
querying, by the computer, a database to retrieve a list of ingredients for the pizza based on the order;
displaying, on a monitor operably connected to the computer, instructions for assembling the pizza based on the list of ingredients; and
continuously weighing the pizza using a scale to confirm that an appropriate amount of each ingredient from the list of ingredients is applied to the pizza.

2. The method as recited in claim 1, wherein the step of continuously weighing the pizza using the scale includes (a) outputting a signal representative of the weight of the pizza from the scale to the computer, and (b) displaying a visual cue on the monitor that is representative of the weight of the pizza.

3. The method of claim 2, in which the visual cue is a moveable icon that moves along and relative to a static icon in response to the increase or decrease of the weight of the pizza.

4. A method for assembling a pizza, comprising the steps of:
receiving, by a computer, an order for the pizza;
querying, by the computer, a database to retrieve a list of ingredients for the pizza based on the order;
displaying, on a monitor operably connected to the computer, instructions for assembling the pizza based on the list of ingredients;
continuously weighing the pizza using a scale;
outputting a signal representative of the weight of the pizza from the scale to the computer; and
displaying a visual cue on the monitor that is representative of the weight of the pizza as each ingredient from the list of ingredients is applied to the pizza.

5. The method of claim 4, in which the visual cue is a moveable icon that moves along and relative to a static icon in response to the increase or decrease of the weight of the pizza.

6. A method for assembling a pizza, comprising the steps of:
(a) receiving, by a computer, an order for the pizza;
(b) querying, by the computer, a database to retrieve a list of ingredients for the pizza based on the order;
(c) displaying, on a monitor operably connected to the computer, instructions to apply a selected ingredient to the pizza based on the list of ingredients;
(d) continuously weighing the pizza using a scale as the selected ingredient is applied to the pizza, and outputting a signal representative of the weight of the pizza to the computer;
(e) providing a visual indication on the monitor as to the weight of the pizza as the selected ingredient is applied to the pizza, and providing a visual indication on the monitor when a prescribed amount of the selected ingredient has been applied to the pizza; and
(f) repeating steps (c)-(e) until all ingredients from the list of ingredients have been applied to the pizza.

7. A system for assembling a pizza, comprising:
a computer configured for receiving an order for the pizza;
a database accessible by the computer for providing a list of ingredients for the pizza based on the order;
a monitor operably connected to the computer and positioned in an order preparation area for displaying instructions for assembling the pizza; and
a scale operably connected to the computer for continuously weighing the pizza during assembly of the pizza.

8. The system as recited in claim 7, wherein a signal representative of the weight of the pizza is outputted from the scale to the computer during assembly of the pizza, such that a visual cue can be displayed in on the monitor that is representative of the weight of the pizza.
